(19) United States
(12) Patent Application Publication
(10) Pub. No.: US 2026/0268144 A1
(43) Pub. Date: Sep. 10, 2026

(54) INFORMATION PROCESSING APPARATUS, INFORMATION PROCESSING METHOD, AND NON-TRANSITORY STORAGE MEDIUM

(71) Applicant: SONY GROUP CORPORATION, TOKYO (JP)

(72) Inventors: MASAKI FURUKAWA, TOKYO (JP); YUJI NISHIMAKI, TOKYO (JP)

(21) Appl. No.: 19/165,993

(22) PCT Filed: Mar. 31, 2023
(86) PCT No.: PCT/JP2023/013451

§ 371 Date: Sep. 16, 2025

(51) Int. Cl. G06N 3/082; G06N 3/0895

(52) U.S. Cl. CPC G06N 3/082; G06N 3/0895

(57) ABSTRACT

An information processing apparatus includes: a generation unit that assigns a pseudo label, which is a pseudo label, to data, so as to generate a pseudo data set including the data assigned the pseudo label; a determination unit that determines whether or not a loss value of a loss function used for optimization calculation of a neural architecture search algorithm is equal to or greater than a predetermined threshold, in a case where the pseudo data set is input to the neural architecture search algorithm; and an output control unit that outputs structure information regarding a structure of a neural network, in a case where the determination unit determines that the loss value is equal to or greater than the predetermined threshold.

### FIELD

The present invention relates to an information processing apparatus, an information processing method, and a non-transitory storage medium.

### BACKGROUND

Conventionally, a technique related to a neural architecture search (NAS, hereinafter, may be referred to as NAS) algorithm for searching for a structure of a neural network according to a target data set by optimization calculation is known. In addition, conventionally, in the calculation of the NAS algorithm, it is necessary to prepare a large number of data sets to which an annotation (hereinafter, also referred to as a label) that is correct for target data such as an image is assigned.

On the other hand, a method of utilizing unlabeled data for the calculation of the NAS algorithm has been proposed. For example, there is known a technique (hereinafter, may be referred to as an UnrealNAS algorithm) of generating a pseudo data set including an image assigned a pseudo label by randomly assigning an arbitrary pseudo label at an image level to each unlabeled image, and using the pseudo data set as an input of the NAS algorithm.

### CITATION LIST

### Non Patent Literature

Non Patent Literature 1: Zhen Dong and seven others, “UnrealNAS: Can We Search Neural Architectures with Unreal Data?” [online], May 2022, [searched on Mar. 20, 2023], Internet <https://arxiv.org/pdf/2205.02162.pdf>

### SUMMARY

### Technical Problem

However, the above-described conventional technique merely generates the pseudo data set including an image assigned a pseudo label and uses the pseudo data set as the input of the NAS algorithm, and thus it is not always possible to efficiently search for the structure of the neural network.

In this regard, the present disclosure proposes an information processing apparatus, an information processing method, and a non-transitory storage medium capable of efficiently searching for a structure of a neural network.

### Solution to Problem

To solve the above problem, an information processing apparatus includes: a generation unit that assigns a pseudo label, which is a pseudo label, to data, so as to generate a pseudo data set including the data assigned the pseudo label; a determination unit that determines whether or not a loss value of a loss function used for optimization calculation of a neural architecture search algorithm is equal to or greater than a predetermined threshold, in a case where the pseudo data set is input to the neural architecture search algorithm; and an output control unit that outputs structure information regarding a structure of a neural network, in a case where the determination unit determines that the loss value is equal to or greater than the predetermined threshold.

### BRIEF DESCRIPTION OF DRAWINGS

FIG. 1 is a diagram illustrating a configuration example of an information processing apparatus according to an embodiment of the present disclosure.

FIG. 2 is a flowchart illustrating a flow of information processing by the information processing apparatus according to the embodiment.

FIG. 3 is a diagram for explaining processing of assigning a pseudo label according to the embodiment.

FIG. 4 is an overall diagram of a system according to the embodiment.

FIG. 5 is a diagram illustrating an example of a control slider according to the embodiment.

FIG. 6 is a hardware configuration diagram illustrating an example of a computer that implements functions of the information processing apparatus according to the present disclosure.

### DESCRIPTION OF EMBODIMENTS

Hereinafter, embodiments of the present disclosure will be described in detail on the basis of the drawings. Incidentally, in each of the following embodiments, the same reference numerals are given to the same portions, and duplicate description will be omitted.

### EMBODIMENT

### [1. Introduction]

In recent years, image diagnosis artificial intelligence (AI) that supports diagnosis of a medical image has been known. For example, each pixel of an image which is obtained by imaging a human cell (hereinafter, may be referred to as a cell image) is assigned a label indicating whether or not the pixel is a cell region to be noted, and a training data set including the cell image is generated as an example of the medical image. Subsequently, in a case where the cell image included in the training data set is input, a neural network is trained so as to output a correct image in which the cell region to be noted and a region other than the cell region to be noted are segmented. Here, the neural network to be trained is a convolutional neural network (CNN), fully convolutional networks (FCN), a model of an encoder/decoder structure (SegNet, U-Net, HRNet, or the like), a feature pyramid network (FPN), a region-convolutional neural network (R-CNN), a recurrent neural network (RNN), or the like. An unknown cell image is segmented using the trained neural network generated in this manner. Accordingly, diagnosis by a doctor or the like can be made more efficient.

In addition, there are a large number of medical images that cannot be utilized as training data sets and remain unutilized. Generally, in order to generate a high-performance neural network, it is necessary to create a large number of high-quality training data sets. However, since a training data set including a medical image requires highly specialized medical knowledge in order to assign a correct label, it is difficult for a person other than an expert to create the training data set. In addition, a result of the image diagnosis may be related to the health and life of a patient, and thus when the quality of the label is poor, the image cannot be used as the training data set. Therefore, it is difficult to create a large number of high-quality training data sets. On the other hand, in a medical field, a large number of medical images used for image diagnosis are generated every day. Therefore, a large number of medical images that are not utilized as the training data sets remain unutilized.

In addition, in the UnrealNAS algorithm described above, it is known that even when no label is assigned to target data, structure information of a neural network having desired performance can be automatically generated from the NAS algorithm by assigning an appropriate pseudo label. Here, in the UnrealNAS algorithm, a data set to which a label which is pseudo (hereinafter, may be referred to as a pseudo label) is assigned by a user is used as an input, but it is known that performance of a generated neural network greatly differs depending on a method of the user assigning the pseudo label. On the other hand, for example, an effective index for deciding an optimum pseudo label such as the number of labels to be assigned to each image is not proposed, and in order to generate the neural network having desired performance, a developer need to comprehensively verify the pseudo-labeling method. Such a comprehensive verification operation does not function practically for segmentation tasks that require labels at a pixel level of an image. In addition, it is difficult to realize automatic optimization of the structure of the neural network inherent in the NAS algorithm.

On the other hand, the information processing apparatus according to the present disclosure assigns a pseudo label, which is a pseudo label, to data, so as to generate a pseudo data set including the data assigned the pseudo label. In addition, in a case where the pseudo data set is input to a neural architecture search algorithm, the information processing apparatus determines whether or not a loss value of a loss function used for optimization calculation of the neural architecture search algorithm is equal to or greater than a predetermined threshold. In addition, in a case where it is determined that the loss value is equal to or greater than the predetermined threshold, the information processing apparatus outputs structure information regarding the structure of the neural network.

Accordingly, the information processing apparatus can present an index for evaluating an effective pseudo label as an input, and can efficiently generate, from a data set assigned no label, the neural network having desired performance. For example, when used in a segmentation task that requires a detailed label at a pixel level of an input, the information processing apparatus contributes to both improvement in performance of the generated neural network and reduction in time required to search for the structure of the neural network having desired performance. Therefore, the information processing apparatus can efficiently search for the structure of the neural network.

Note that the NAS algorithm is expressed as a continuous search space in which each component of various deep neural networks (DNNs) defined as discontinuous options can be differentiated, generates structure information regarding a structure of a neural network optimized for an input by optimizing a loss function based on a gradient method, and outputs the structure information. Data input to the NAS algorithm may be, for example, a data set in which target data such as an image, a moving image, a character string, a sentence, and audio data is assigned a correct label. Hereinafter, a case will be described in which the data input to the NAS algorithm is an image.

### [2. Configuration of Information Processing Apparatus]

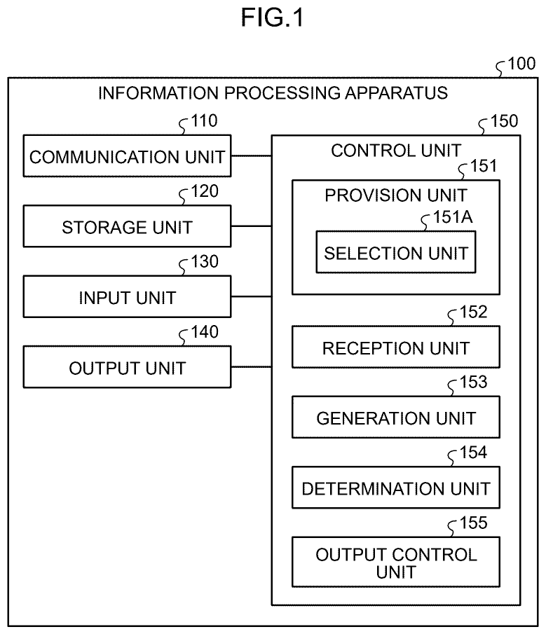

FIG. 1 is a diagram illustrating a configuration example of an information processing apparatus according to an embodiment of the present disclosure. As illustrated in FIG. 1, an information processing apparatus 100 includes a communication unit 110, a storage unit 120, an input unit 130, an output unit 140, and a control unit 150.

The communication unit 110 is implemented by, for example, a network interface card (NIC) or the like. Then, the communication unit 110 may be connected to a network in a wired or wireless manner, and transmit and receive information to and from another information processing apparatus, for example.

The storage unit 120 is implemented by, for example, a semiconductor memory element such as a random access memory (RAM) or a flash memory, or a storage device such as a hard disk or an optical disk. For example, the storage unit 120 stores information regarding various programs.

The input unit 130 is an input device that receives various inputs from an outside. The input unit 130 includes an operation device that receives an input operation of the user. The operation device is a device for the user to perform various operations, such as a keyboard, a mouse, and an operation key. Note that, in a case where a touch panel is adopted as the information processing apparatus 100, the touch panel is also included in the operation device. In this case, the user performs various operations by touching a screen with a finger or a stylus.

The output unit 140 is a display device that displays various types of information. The output unit 140 is, for example, a liquid crystal display, an organic electro luminescence (EL) display, or the like. Note that, in a case where a touch panel is adopted as the information processing apparatus 100, the output unit 140 may be a device integrated with the operation device of the input unit 130. The output unit 140 displays and provides various types of information to the user.

The control unit 150 is a controller, and is implemented by, for example, a central processing unit (CPU), a micro processing unit (MPU), an application specific integrated circuit (ASIC), a field programmable gate array (FPGA), or the like executing various programs stored in a storage device inside the information processing apparatus 100 using a storage region such as a RAM as a work region. In the example illustrated in FIG. 1, the control unit 150 includes a provision unit 151, a reception unit 152, a generation unit 153, a determination unit 154, and an output control unit 155.

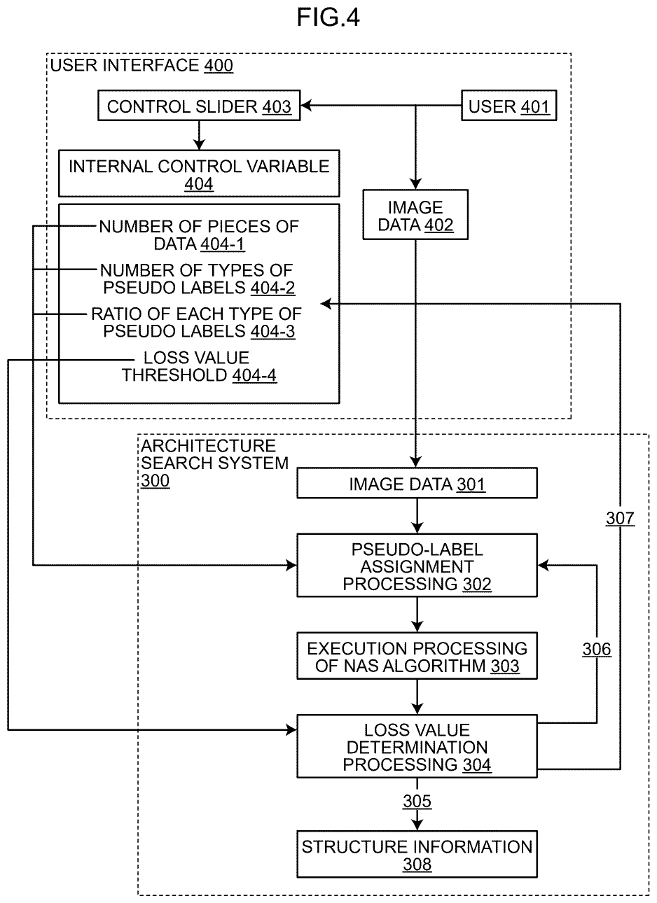

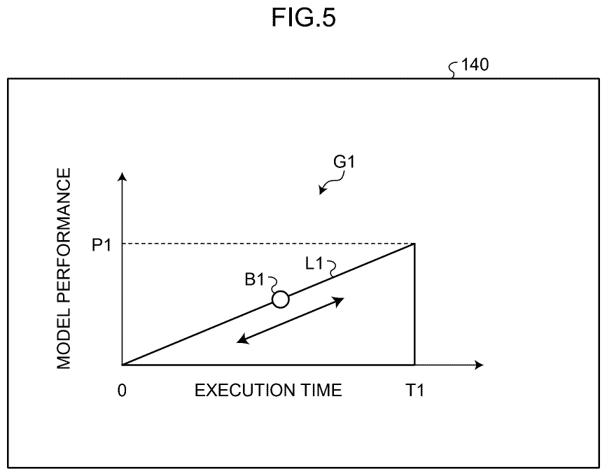

The provision unit 151 provides an architecture search system that executes the neural architecture search algorithm. The architecture search system provided by the provision unit 151 will be described in detail with reference to FIG. 4 to be described later, and thus the description thereof will be omitted here. In addition, the provision unit 151 provides a user interface corresponding to the architecture search system. The user interface of the provision unit 151 will be described in detail with reference to FIGS. 4 and 5 to be described later, and thus the description thereof will be omitted here.

The reception unit 152 receives various operations from the user. Specifically, the reception unit 152 receives a selection operation for selecting a position of a selection unit 151A from the user via the input unit 130. In addition, the reception unit 152 receives data from the user via the input unit 130.

The generation unit 153 assigns a pseudo label, which is a pseudo label, to the data received by the reception unit 152, so as to generate a pseudo data set including the data assigned the pseudo label. For example, the generation unit 153 assigns a pseudo label to the image data, so as to generate a pseudo data set including the image data assigned the pseudo label.

In a case where the pseudo data set is input to the neural architecture search algorithm, the determination unit 154 determines whether or not a loss value of a loss function used for optimization calculation of the neural architecture search algorithm is equal to or greater than a predetermined threshold.

In a case where the determination unit 154 determines that the loss value is equal to or greater than the predetermined threshold, the output control unit 155 outputs structure information regarding a structure of a neural network. The structure information is information regarding the structure of the neural network optimized for input data (also referred to as a neural network architecture) or information necessary for the configuration thereof. For example, the structure information is information regarding the structure of the neural network such as a type of pooling processing or convolution processing, and an activation function. Note that the structure information may be the neural network itself optimized for the input data.

### [3. Procedure of Information Processing]

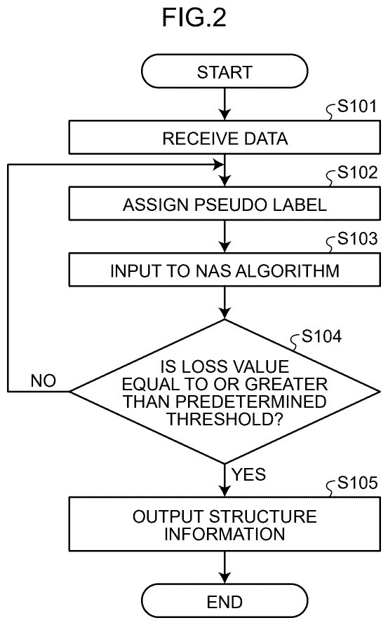

FIG. 2 is a flowchart illustrating a flow of information processing by the information processing apparatus according to the embodiment of the present disclosure. In FIG. 2, the reception unit 152 receives data from the user (step S101). For example, the reception unit 152 receives image data from the user. For example, the reception unit 152 receives a medical image from the user. Hereinafter, a case will be described in which the data is image data (medical image).

In addition, the generation unit 153 assigns a pseudo label to the image data received by the reception unit 152, so as to generate a pseudo data set (step S102). Subsequently, in a case where the pseudo data set is generated, the generation unit 153 inputs the pseudo data set to the neural architecture search algorithm (step S103). Subsequently, in a case where the pseudo data set is input to the neural architecture search algorithm, the generation unit 153 executes optimization calculation of the neural architecture search algorithm.

In addition, in a case where the pseudo data set is input to the neural architecture search algorithm by the generation unit 153, the determination unit 154 determines whether or not the loss value of the loss function used for optimization calculation of the neural architecture search algorithm is equal to or greater than the predetermined threshold (step S104). In a case where the determination unit 154 determines that the loss value is equal to or greater than the predetermined threshold (step S104; Yes), the output control unit 155 outputs the structure information regarding the structure of the neural network (step S105).

In addition, in a case where the determination unit 154 determines that the loss value is less than the predetermined threshold (step S104; No), the generation unit 153 generates a new pseudo data set including data assigned a new pseudo label, by assigning the new pseudo label to the image data received by the reception unit 152 (step S102). Subsequently, in a case where the new pseudo data set is generated, the generation unit 153 inputs the new pseudo data set to the neural architecture search algorithm (step S103). Subsequently, in a case where the new pseudo data set is input to the neural architecture search algorithm, the generation unit 153 executes optimization calculation of the neural architecture search algorithm again.

In addition, in a case where the new pseudo data set is input to the neural architecture search algorithm, the determination unit 154 determines whether or not the loss value is equal to or greater than the predetermined threshold (step S104). In a case where the determination unit 154 determines that the loss value is equal to or greater than the predetermined threshold (step S104; Yes), the output control unit 155 outputs the structure information (step S105). In addition, in a case where the determination unit 154 determines that the loss value is less than the predetermined threshold (step S104; No), the generation unit 153 executes processing subsequent to step S102.

In an NAS algorithm using, as an input, a pseudo data set assigned an arbitrary pseudo label, performance of a neural network obtained as a final output result varies significantly depending on the method of assigning the pseudo label. In this regard, in deciding an effective pseudo-label assignment method that can generate a neural network having higher performance, the information processing apparatus 100 uses the loss value of the loss function used when the structure of the neural network is optimized in the NAS algorithm. In general, in a normal NAS algorithm using a data set assigned an accurate label, the structure of the neural network is optimized by searching for a parameter for minimizing a loss value due to a loss function. On the other hand, in the method using, as an input, the pseudo data set assigned the pseudo label, the excessive optimization of the loss function contributes to the degradation of the performance of the neural network that can be generated as an output. That is, the performance of the neural network that can be generated when the pseudo data set that relatively decreases the loss value is used as an input is relatively low. This is because the structure of the generated neural network is excessively adapted to a specific pattern of the pseudo label, so that the neural network does not function effectively when transferred and trained on a desired data set.

On the other hand, in determination processing of the loss value of the loss function used for the optimization calculation of the neural architecture search algorithm (hereinafter, may be abbreviated as “loss value determination processing”) illustrated in step S104, the information processing apparatus 100 sets an additional constraint on the loss value of the loss function used for optimizing the structure of the neural network, and controls the structure information that is a final output. Specifically, the final output is allowed only in a case where the loss value of the loss function is equal to or greater than the predetermined threshold, and in a case where the loss value is less than the threshold, the pseudo label is assigned to the input again, and the search by the NAS algorithm is executed again. Accordingly, the information processing apparatus 100 can prevent the structure of the generated neural network from being excessively adapted to the specific pattern of the pseudo label.

In addition, in the loss value determination processing, the threshold used as the constraint on the loss value of the loss function is a heuristic hyperparameter that changes depending on the NAS algorithm or an input condition. In general, as the threshold is set to a relatively large value, a pseudo-label assignment pattern that is excessively optimized is more likely to be excluded, so that the performance of the neural network that can be generated as the output is improved. In addition, with introduction of the loss value determination processing, it is possible to present an index for evaluating a method of assigning an effective pseudo label as an input, and it is possible to efficiently generate, from a data set assigned no label, the neural network having desired performance. In particular, when used in a segmentation task that requires detailed annotations at a pixel level, the loss value determination processing contributes to both improvement in performance of the generated neural network and reduction in time required to search for the structure of the neural network having desired performance.

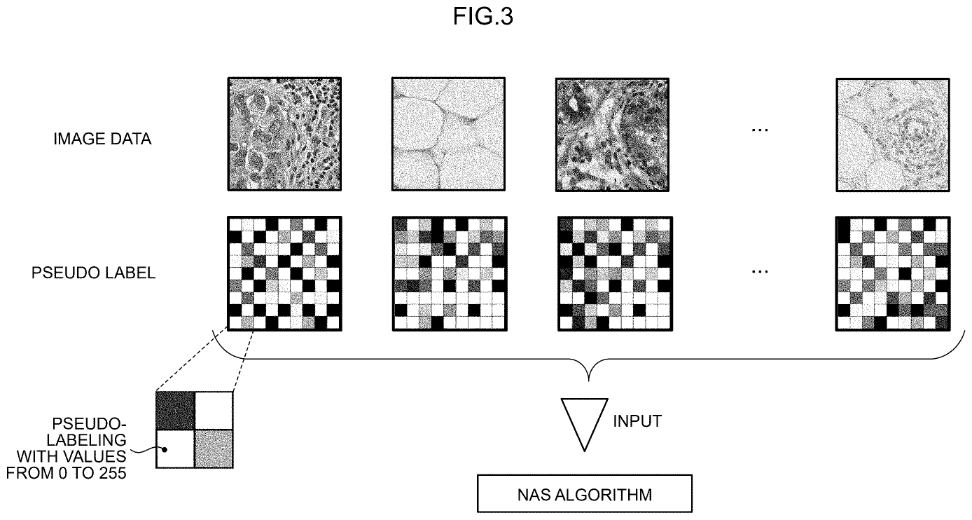

FIG. 3 is a diagram for describing processing of assigning a pseudo label according to the embodiment of the present disclosure. In FIG. 3, processing of generating a pseudo data set used for a segmentation task will be described. In FIG. 3, the generation unit 153 generates a pseudo data set by assigning a pseudo label to each pixel of the image received by the reception unit 152. The generation unit 153 generates a pseudo data set by assigning a pseudo label at a pixel level to each image. For example, the generation unit 153 generates a pseudo data set by assigning, as a pseudo label value, any value from 0 to 255 to each pixel of the image. In addition, the generation unit 153 generates a pseudo data set by changing, for each image, an appearance probability of the pseudo label value assigned to each pixel. Subsequently, in a case where the pseudo data set is generated, the generation unit 153 inputs the pseudo data set to the neural architecture search algorithm. Subsequently, in a case where the pseudo data set is input to the neural architecture search algorithm, the generation unit 153 executes optimization calculation of the neural architecture search algorithm. In addition, the output control unit 155 outputs structure information regarding the structure of the neural network used for the segmentation task.

FIG. 4 is an overall diagram of a system according to the embodiment of the present disclosure. In FIG. 4, the provision unit 151 provides an architecture search system (300) that executes the neural architecture search algorithm. The architecture search system (300) receives any type of unlabeled image data (301) as the input of the neural architecture search algorithm, generates structure information (308), which is information necessary for a structure of a neural network optimized for the input image data (301) or the configuration thereof, by a series of processes to be described later, and outputs the structure information.

The architecture search system (300) includes the reception unit 152, the generation unit 153, the determination unit 154, and the output control unit 155 illustrated in FIG. 1. For example, the reception unit 152 receives image data (301). The image data (301) received by the reception unit 152 is output, as an input to pseudo-label assignment processing (302), to the generation unit 153.

The generation unit 153 executes the pseudo-label assignment processing (302). Specifically, the generation unit 153 assigns a dynamic pseudo label to the image data (301) acquired from the reception unit 152, and generates a pseudo data set used as teacher data when the structure of the neural network is optimized.

Subsequently, the generation unit 153 executes execution processing (303) of the neural architecture search algorithm. Specifically, the generation unit 153 inputs the generated pseudo data set to the neural architecture search algorithm. For example, the generation unit 153 executes optimization calculation of an arbitrary search algorithm, which is optimizes a search parameter defined as a differentiable continuous space by a gradient method, as the neural architecture search algorithm. For example, the generation unit 153 may execute optimization calculation of a differential architecture search (DARTS) algorithm or a sequential greedy architecture search (SGAS) algorithm as the neural architecture search algorithm.

The determination unit 154 executes loss value determination processing (304). Specifically, in the execution processing (303) of the neural architecture search algorithm, the determination unit 154 controls the performance of the generated neural network by monitoring and evaluating the loss value of the loss function used for the optimization calculation of the structure of the neural network. Here, the loss function used for the optimization calculation is not limited to a specific function, and any loss function can be adopted according to the task. For example, the loss function may be Binary Closs-Entropy Loss or Closs-Entropy Loss. The determination unit 154 compares a magnitude of the loss value of the loss function with a predefined threshold (predetermined threshold), and determines whether or not a condition that the loss value of the loss function is equal to or greater than the predetermined threshold is satisfied.

The output control unit 155 outputs the structure information (308) only in a case where the condition that the loss value of the loss function is equal to or greater than the predetermined threshold is satisfied (305). On the other hand, in a case where the condition that the loss value of the loss function is equal to or greater than the predetermined threshold is not satisfied, the generation unit 153 re-assigns the pseudo label to the image data (301) and re-executes the execution processing (303) of the neural architecture search algorithm (306).

In addition, the provision unit 151 provides a user interface (400) corresponding to the architecture search system (300). The user interface (400) is an interface for the user to interact with the architecture search system (300). In the user interface (400), a user (401) is an entity that interacts with the entire system and provides image data (402) as an input to the user interface (400). The image data (402) may take a visual image of any domain. For example, the image data (402) provided by the user (401) may be images of natural objects captured with a camera system. In addition, as another example, the image data (402) provided by the user (401) may be an image of a biological object (an example of a medical image) captured via a corresponding medical imaging system.

In the user interface (400), the user (401) further makes an input to a control slider (403). Accordingly, the user (401) relatively controls a desired execution time required from the input of the image data (402) to the output of the structure information (308). The control slider (403) is expressed as a slider-like interface that maps a relationship between the performance of the neural network corresponding to the structure information output from the architecture search system (300) and the execution time of the neural architecture search algorithm.

An internal control variable (404) illustrated in FIG. 4 is a pseudo parameter to be described later. The internal control variable (404) controls a trade-off between the performance of the neural network corresponding to the structure information output from the architecture search system (300) and the execution time of the neural architecture search algorithm. There is the final output accuracy and the execution time in the entire system have a strong correlation via each variable in the internal control variable (404), and in the ideal system, as the execution time required for the output increases, the performance of the neural network that can be generated is improved. Each variable in the internal control variables (404) is designed as a heuristic parameter based on a relative value of the control slider (403).

FIG. 5 is a diagram illustrating an example of the control slider according to the embodiment of the present disclosure. The provision unit 151 provides the selection unit 151A in which, when one of the execution time of the neural architecture search algorithm and the performance of the neural network corresponding to the structure information output by the output control unit 155 is selected, the other is decided. For example, the provision unit 151 causes the output unit 140 to display a screen as illustrated in FIG. 5. For example, the provision unit 151 provides a control slider B1 as the selection unit 151A. The control slider B1 corresponds to the control slider (403) illustrated in FIG. 4.

The generation unit 153 generates a pseudo data set on the basis of the value of the pseudo parameter decided according to the position of the selection unit 151A corresponding to the selection operation received by the reception unit 152. The output control unit 155 outputs the structure information on the basis of the predetermined threshold decided according to the position of the selection unit 151A corresponding to the selection operation received by the reception unit 152. The value of the pseudo parameter is a value indicating the number of pieces of data, a value indicating the number of types of pseudo labels, a value indicating a ratio of each type of pseudo labels, and the predetermined threshold.

The description returns to FIG. 4. The internal control variable (404) illustrated in FIG. 4 corresponds to the above-described pseudo parameter. The internal control variable (404) includes the number of pieces of data (404-1), the number of types of pseudo labels (404-2), the ratio of each type of pseudo labels (404-3), and a loss value threshold (404-4).

The number of types of pseudo labels (404-2) indicates the number of pseudo labels assigned to each pixel of the image data. When applied to the example of FIG. 3, the number of types of pseudo labels (404-2) corresponds to the number of values used as pseudo label values among values from 0 to 255. In general, as the value of the number of types of pseudo labels (404-2) increases, the performance of the neural network that can be generated as an output is improved. On the other hand, since a certain data amount or more is required for each assigned pseudo class-label, the number of pieces of input data (404-1) required for the entire system increases, and the execution time required for output increases.

The ratio of each type of pseudo labels (404-3) is a variable that controls a probability distribution in which each pseudo label defined by the number of types of pseudo labels (404-2) is set to each pixel of the image. In general, it is expected that the performance of the neural network is improved by assigning pseudo labels with different probabilities at an image level, but a random value are used for each probability. In addition, in a case where the loss value determination processing (304) to the pseudo-label assignment processing (302) are repeatedly executed (306), the generation unit 153 randomly changes the ratio of each type of pseudo labels (404-3).

The loss value threshold (404-4) is a parameter for controlling the loss value threshold (predetermined threshold) in the loss value determination processing (304). As the loss value threshold (404-4) is set to a larger value, the execution time increases along with the number of times of trial of the search algorithm, but the performance of the finally obtained neural network is improved.

### [4. Effects]

As described above, the information processing apparatus 100 according to each embodiment of the present disclosure includes the generation unit 153, the determination unit 154, and the output control unit 155. The generation unit 153 assigns the pseudo label, which is a pseudo label, to data, so as to generate a pseudo data set including the data assigned the pseudo label. In a case where the pseudo data set is input to the neural architecture search algorithm, the determination unit 154 determines whether or not a loss value of a loss function used for optimization calculation of the neural architecture search algorithm is equal to or greater than a predetermined threshold. In a case where the determination unit 154 determines that the loss value is equal to or greater than the predetermined threshold, the output control unit 155 outputs structure information regarding a structure of a neural network.

Accordingly, the information processing apparatus 100 can present an index for evaluating an effective pseudo label as an input, and can efficiently generate, from a data set assigned no label, the neural network having desired performance. For example, when used in a segmentation task that requires a detailed label at a pixel level of an input, the information processing apparatus 100 contributes to both improvement in performance of the generated neural network and reduction in time required to search for the structure of the neural network having desired performance. Therefore, the information processing apparatus 100 can efficiently search for the structure of the neural network.

In addition, in a case where the determination unit 154 determines that the loss value is less than the predetermined threshold, the generation unit 153 generates a new pseudo data set including data assigned a new pseudo label, by assigning the new pseudo label to the data. In a case where the new pseudo data set is input to the neural architecture search algorithm, the determination unit 154 determines whether or not the loss value is equal to or greater than the predetermined threshold. In a case where the determination unit 154 determines that the loss value is equal to or greater than the predetermined threshold, the output control unit 155 outputs the structure information.

Accordingly, the information processing apparatus 100 can efficiently generate, from a data set assigned no label, the neural network having desired performance.

In addition, the generation unit 153 generates a pseudo data set by assigning a pseudo label to each pixel of an image that is data. The output control unit 155 outputs structure information regarding the structure of the neural network used for the segmentation task.

Accordingly, in the neural architecture search system for the segmentation task, the information processing apparatus 100 can improve the performance of the neural network that can be generated.

In addition, the information processing apparatus 100 further includes the provision unit 151 and the reception unit 152. The provision unit 151 provides the selection unit 151A in which, when one of the execution time of the neural architecture search algorithm and the performance of the neural network corresponding to the structure information output by the output control unit 155 is selected, the other is decided. The reception unit 152 receives a selection operation for selecting the position of the selection unit 151A from the user. The generation unit 153 generates a pseudo data set on the basis of the value of the pseudo parameter decided according to the position of the selection unit 151A corresponding to the selection operation received by the reception unit 152. The output control unit 155 outputs the structure information on the basis of the predetermined threshold decided according to the position of the selection unit 151A corresponding to the selection operation received by the reception unit 152.

Accordingly, the information processing apparatus 100 can provide a function for controlling the execution time (that is, a time required for automatic design of the neural network) of the neural architecture search algorithm to the user who is the designer of the neural network. In addition, the information processing apparatus 100 enables the user to efficiently control the structure of the neural network by the user interacting with the neural architecture search algorithm via the constraint of the execution time of the neural architecture search algorithm.

In addition, the value of the pseudo parameter is a value indicating the number of pieces of data, a value indicating the number of types of pseudo labels, a value indicating a ratio of each type of pseudo labels, and the predetermined threshold.

Accordingly, the information processing apparatus 100 enables the user to efficiently control the structure of the neural network by the user interacting with the neural architecture search algorithm via the constraint of the execution time of the neural architecture search algorithm.

### [5. Hardware Configuration]

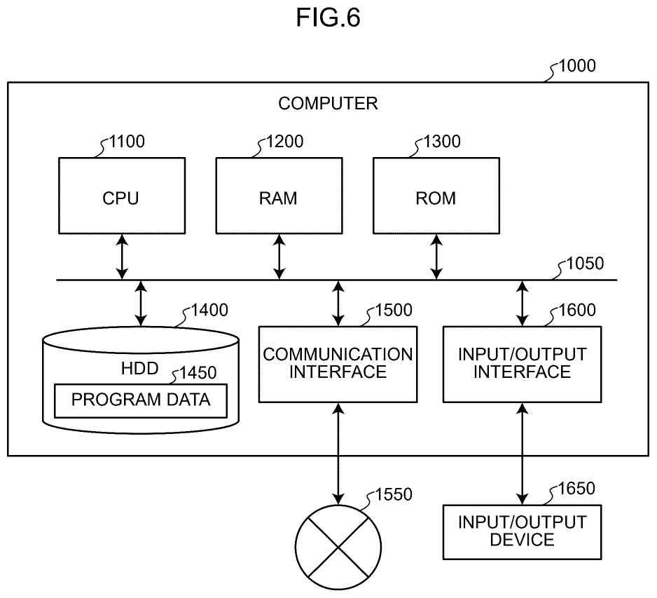

The information processing apparatus 100 according to the above-described embodiment is reproduced by a computer 1000 having a configuration as illustrated in FIG. 6, for example. FIG. 6 is a hardware configuration diagram illustrating an example of a computer that implements functions of the information processing apparatus 100 according to the present disclosure. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops the program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a non-transitory computer-readable recording medium that non-transiently records a program executed by the CPU 1100, data used by the program, and the like. Specifically, the HDD 1400 is a non-transitory recording medium that records a program according to the present disclosure as an example of program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard and a mouse via the input/output interface 1600. Further, the CPU 1100 transmits data to an output device such as a display, a speaker, or a printer via the input/output interface 1600. Further, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing apparatus 100 according to the embodiment, the CPU 1100 of the computer 1000 reproduces the functions of the control unit 150 and the like by executing a program loaded on the RAM 1200. In addition, the HDD 1400 stores the program according to the present disclosure and various types of data.

Incidentally, the CPU 1100 reads the program data 1450 from the HDD 1400 and executes the program data, but as another example, these programs may be acquired from another device via the external network 1550.

Further, the effects described in this specification are merely illustrative or exemplary and are not limited. That is, the technique according to the present disclosure can exhibit other effects that are apparent to those skilled in the art from the description of this specification in addition to or instead of the above effects.

Incidentally, the present technique may also be configured as below.

(1)

An information processing apparatus comprising:
a generation unit that assigns a pseudo label, which is a pseudo label, to data, so as to generate a pseudo data set including the data assigned the pseudo label;
a determination unit that determines whether or not a loss value of a loss function used for optimization calculation of a neural architecture search algorithm is equal to or greater than a predetermined threshold, in a case where the pseudo data set is input to the neural architecture search algorithm; and
an output control unit that outputs structure information regarding a structure of a neural network, in a case where the determination unit determines that the loss value is equal to or greater than the predetermined threshold.
   (2)

The information processing apparatus according to (1), wherein
the generation unit
in a case where the determination unit determines that the loss value is less than the predetermined threshold, assigns a new pseudo label to the data so as to generate a new pseudo data set including the data assigned the new pseudo label,
the determination unit
in a case where the new pseudo data set is input to the neural architecture search algorithm, determines whether or not the loss value is equal to or greater than the predetermined threshold, and
the output control unit
in a case where the determination unit determines that the loss value is equal to or greater than the predetermined threshold, outputs the structure information.
   (3)

The information processing apparatus according to (1) or (2), wherein
the generation unit
assigns the pseudo label to each pixel of an image that is the data, so as to generate the pseudo data set, and
the output control unit
outputs the structure information regarding a structure of the neural network used for a segmentation task.
   (4)

The information processing apparatus according to any one of (1) to (3), further comprising:
a provision unit that provides a selection unit in which, when one of an execution time of the neural architecture search algorithm and performance of the neural network corresponding to the structure information output by the output control unit is selected, the other is decided; and
a reception unit that receives, from a user, a selection operation of selecting a position of the selection unit, wherein
the generation unit
generates the pseudo data set on a basis of a value of a pseudo parameter decided according to the position of the selection unit corresponding to the selection operation received by the reception unit, and
the output control unit
outputs the structure information on a basis of the predetermined threshold decided according to the position of the selection unit corresponding to the selection operation received by the reception unit.
   (5)

The information processing apparatus according to (4), wherein
the value of the pseudo parameter is a value indicating the number of pieces of the data, a value indicating the number of types of the pseudo labels, a value indicating a ratio of each type of the pseudo labels, and the predetermined threshold.
   (6)

An information processing method comprising:
assigning a pseudo label, which is a pseudo label, to data, so as to generate a pseudo data set including the data assigned the pseudo label;
determining whether or not a loss value of a loss function used for optimization calculation of a neural architecture search algorithm is equal to or greater than a predetermined threshold, in a case where the pseudo data set is input to the neural architecture search algorithm; and
outputting structure information regarding a structure of a neural network, in a case where it is determined that the loss value is equal to or greater than the predetermined threshold.
   (7)

A computer-readable non-transitory storage medium having stored thereon a program for causing a computer to implement:
assigning a pseudo label, which is a pseudo label, to data, so as to generate a pseudo data set including the data assigned the pseudo label;
determining whether or not a loss value of a loss function used for optimization calculation of a neural architecture search algorithm is equal to or greater than a predetermined threshold, in a case where the pseudo data set is input to the neural architecture search algorithm; and
outputting structure information regarding a structure of a neural network, in a case where it is determined that the loss value is equal to or greater than the predetermined threshold.

### REFERENCE SIGNS LIST

100 INFORMATION PROCESSING APPARATUS
110 COMMUNICATION UNIT
120 STORAGE UNIT
130 INPUT UNIT
140 OUTPUT UNIT
150 CONTROL UNIT
151 PROVISION UNIT
151A SELECTION UNIT
152 RECEPTION UNIT
153 GENERATION UNIT
154 DETERMINATION UNIT
155 OUTPUT CONTROL UNIT

1. An information processing apparatus comprising:
a generation unit that assigns a pseudo label, which is a pseudo label, to data, so as to generate a pseudo data set including the data assigned the pseudo label;
a determination unit that determines whether or not a loss value of a loss function used for optimization calculation of a neural architecture search algorithm is equal to or greater than a predetermined threshold, in a case where the pseudo data set is input to the neural architecture search algorithm; and
an output control unit that outputs structure information regarding a structure of a neural network, in a case where the determination unit determines that the loss value is equal to or greater than the predetermined threshold.

2. The information processing apparatus according to claim 1, wherein
the generation unit
in a case where the determination unit determines that the loss value is less than the predetermined threshold, assigns a new pseudo label to the data so as to generate a new pseudo data set including the data assigned the new pseudo label,
the determination unit
in a case where the new pseudo data set is input to the neural architecture search algorithm, determines whether or not the loss value is equal to or greater than the predetermined threshold, and
the output control unit
in a case where the determination unit determines that the loss value is equal to or greater than the predetermined threshold, outputs the structure information.

3. The information processing apparatus according to claim 1, wherein
the generation unit
assigns the pseudo label to each pixel of an image that is the data, so as to generate the pseudo data set, and
the output control unit
outputs the structure information regarding a structure of the neural network used for a segmentation task.

4. The information processing apparatus according to claim 1, further comprising:
a provision unit that provides a selection unit in which, when one of an execution time of the neural architecture search algorithm and performance of the neural network corresponding to the structure information output by the output control unit is selected, the other is decided; and
a reception unit that receives, from a user, a selection operation of selecting a position of the selection unit, wherein
the generation unit
generates the pseudo data set on a basis of a value of a pseudo parameter decided according to the position of the selection unit corresponding to the selection operation received by the reception unit, and
the output control unit
outputs the structure information on a basis of the predetermined threshold decided according to the position of the selection unit corresponding to the selection operation received by the reception unit.

5. The information processing apparatus according to claim 4, wherein
the value of the pseudo parameter is a value indicating the number of pieces of the data, a value indicating the number of types of the pseudo labels, a value indicating a ratio of each type of the pseudo labels, and the predetermined threshold.

6. An information processing method comprising:
assigning a pseudo label, which is a pseudo label, to data, so as to generate a pseudo data set including the data assigned the pseudo label;
determining whether or not a loss value of a loss function used for optimization calculation of a neural architecture search algorithm is equal to or greater than a predetermined threshold, in a case where the pseudo data set is input to the neural architecture search algorithm; and
outputting structure information regarding a structure of a neural network, in a case where it is determined that the loss value is equal to or greater than the predetermined threshold.

7. A computer-readable non-transitory storage medium having stored thereon a program for causing a computer to implement:
assigning a pseudo label, which is a pseudo label, to data, so as to generate a pseudo data set including the data assigned the pseudo label;
determining whether or not a loss value of a loss function used for optimization calculation of a neural architecture search algorithm is equal to or greater than a predetermined threshold, in a case where the pseudo data set is input to the neural architecture search algorithm; and
outputting structure information regarding a structure of a neural network, in a case where it is determined that the loss value is equal to or greater than the predetermined threshold.
